(19) United States
(12) Patent Application Publication
(10) Pub. No.: US 2019/0299311 A1
(43) Pub. Date: Oct. 3, 2019

(54) High Power Dual Sensor Cartridge

(71) Applicant: Hakko Corporation, Osaka (JP)

(72) Inventors: Toshikazu Mochizuki, Osaka (JP); Hitoshi Takeuchi, Osaka (JP); Koji Miyahara, Osaka (JP)

(73) Assignee: Hakko Corporation, Osaka (JP)

(21) Appl. No.: 15/938,835

(22) Filed: Mar. 28, 2018

(51) Int. Cl. B23K 3/03

(52) U.S. Cl. CPC B23K 3/033; B23K 3/0353

(57) ABSTRACT

A cartridge for a soldering system that is capable of being powered by a 400 Watt power supply and which includes a pair of sensors to provide precise and rapid control over the temperature of the soldering cartridge tip.

### BACKGROUND OF THE INVENTION

### Field of the Invention

The present invention relates to the field of soldering systems used in the fabrication and repair of electrical components. More specifically, the present invention describes a soldering cartridge for use with a 400 Watt power supply that incorporates two temperature sensors in the distal end of the soldering cartridge to provide enhanced temperature control of the soldering tip.

### Background and Related Art

Soldering systems are used in a variety of industries to fabricate and repair electronic components. Soldering systems used in mass production facilities may be used to repetitively solder multiple points in short intervals. For example, a robotically controlled soldering system may solder ten to fifty or more discrete locations on a circuit board in an automated assembly line. In these types of environments, the speed at which the soldering system can perform the required soldering tasks may be the time limiting factor for the assembly line. These types of soldering systems typically include a power supply and control station, a cable including a handle, and one or more soldering cartridges configured to be inserted into the handle and there-through connected to the control station. The control station typically includes a processor and memory as well as inputs and displays that allow a user to setup the power supply for controlling each type of soldering cartridge that may be used with the soldering system, The control station includes circuitry that allows the control station to receive data signals from a temperature sensor associated with the cartridge, and programming to control the delivery of power to the cartridge to maintain the tip temperature of the cartridge at or near the set temperature point.

Each type of soldering cartridge will have a tip that may be formed in the shape of a cone, beveled edge, flat edge or other shape commonly known. Each individual tip shape will have a thermal mass, the temperature of which may be controlled by cycling power to a heater in the cartridge. However, when the tip of the cartridge is placed into contact with the electrical component to be soldered, and also upon application of a source of solder, heat flows from the tip to the components and the solder and the temperature of the tip will drop. In order to attempt to maintain the tip temperature at the set point during the soldering procedure, the power supply must receive temperature signal data from the temperature sensor associated with the cartridge, recognize that the temperature has dropped, and cycle additional power to the heater. In this process, overheating of the tip may in response to a perceived drop in the tip temperature may damage the heater assembly in the cartridge or even the electrical components being soldered. Accurately controlling the power supplied to the heater of the cartridge is thus a primary concern in the design of the soldering system, particularly when the soldering system is to be used in repetitive soldering operations on an assembly line.

A prior art version of a soldering cartridge is described in U.S. Pat. No. 6,054,678, hereby incorporated by reference. The cartridge disclosed in the 6,054,678 patent includes a heater assembly and a thermocouple temperature sensor positioned inside of a tip for the soldering cartridge. The 6,054,678 patent discloses the preferred construction of the heater components, including a cylindrical insulating pipe having an axial bore and a heater-sensor assembly mounted on the insulating pipe, which by way of example may be an alumina pipe. A limitation of the configuration of the heater-sensor assembly is that it places the sensor in very close proximity to the heater, such that the sensor may be sensing the temperature of the heater as opposed to the temperature of the tip itself.

### BRIEF DESCRIPTION OF THE PRESENT INVENTION

The invention described herein is directed to a cartridge for a soldering system which includes a pair of thermocouple temperature sensors to provide two temperature measurements that can be used by the control station. The primary sensor is spaced distally from the distal end of the heater within a cavity in close proximity to the tip of the cartridge. A second sensor is positioned within an insulator at the distal end of the heater. The two temperature measurements can be used by the control station to precisely and rapidly control the delivery of power to the heater in the cartridge while preventing overheating.

### BRIEF DESCRIPTION OF THE DRAWINGS:

FIG. 1 is a side view of a soldering cartridge according to the present invention.

FIG. 2 is a cross-sectional view of the construction of a distal end of a soldering cartridge according to the prior art.

FIG. 3 is a cross sectional view of the construction of a distal end of a soldering cartridge according to the present invention.

FIG. 4 is side view of the primary internal components of the soldering cartridge according to the present invention.

FIG. 5 is top view of the primary internal components of the soldering cartridge according to the present invention

FIG. 6 is perspective view of the primary internal components of the soldering cartridge according to the present invention.

FIG. 7 is a side view of the sensors wiring for the sensors of the soldering cartridge according to the present invention.

FIG. 8 is a side view of some of the primary internal components at the distal end of the cartridge of the present invention.

FIG. 9 is a perspective view of an insulator block from the distal end of the cartridge of the present invention.

FIG. 10 is cross sectional view of the cartridge of the present invention.

FIG. 11 is a flow chart for a first control program.

FIGS. 12A and 12B are a flow chart for a second control program.

FIG. 13 is a temperature vs time graph for repetitive soldering test of a prior art soldering cartridge.

FIG. 14 is a temperature vs time graph for repetitive soldering test of the dual sensor cartridge of the present invention.

### DETAILED DESCRIPTION OF THE PREFERRED EMBODIMENT

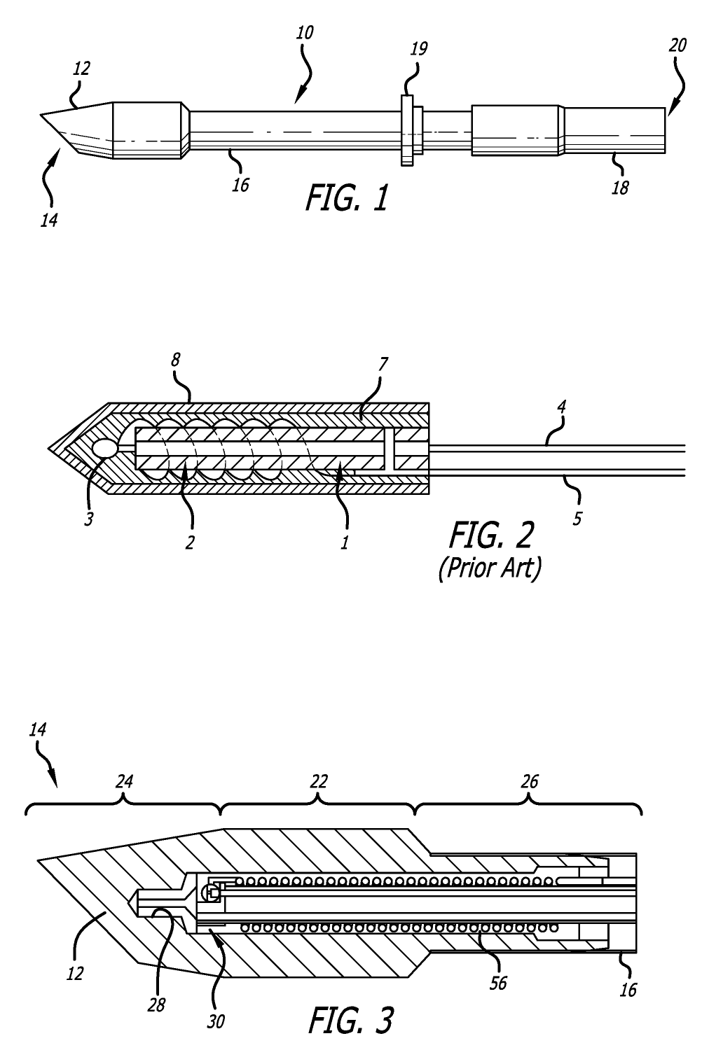

FIG. 1 is a side view of a soldering cartridge 10 according to the present invention. The soldering cartridge 10 includes a tip 12 at the distal end 14, a central pipe body 16 and a connector assembly 18 at the proximal end 20. The proximal end 20 of the soldering cartridge 10 is configured to fit securely within a handle (not shown) allowing connection to a power supply (not shown), as described below.

FIG. 2 depicts the construction of the heater and sensor complex located in the tip at the distal end of a soldering cartridge according to the prior art. The heater and sensor complex includes a hollow cylindrical insulator 1, around which a heater coil 2 is wound. The heater coil 2 is powered by conductor 5 and ground conductor 4. Conductor 5 is connected to one end of the heater coil 2, and the opposite end of the heater coil 2 is connected to the end of conductor 4 at a thermocouple 3, forming a temperature sensor. Conductor 4 extends through the central portion of insulator 1. The insulator 1 and heater coil 2 are encapsulated in a ceramic matrix 7, and the entire outer surface is encased in a metal tip 8. The assembly of the soldering cartridge tip of FIG. 2 is detailed in U.S. Pat. No. 6,054,678, incorporated by reference herein.

FIG. 3 is a cross sectional view of the internal construction of the distal end 14 of the soldering cartridge 10 according to the present invention. The soldering cartridge 10 terminates at a tip 12 formed from copper, which includes a hollow cylindrical section 22 with a shaped end section 24 extending distally and a hollow sleeve section 26 extending proximally. The shaped end section 26 at the proximal end of the tip 12 is sized to be fit securely within the central pipe body 16. The heater-dual sensor complex 30 of the soldering cartridge 10 is mounted within the hollow central section of the tip 12, with the distal end being inserted into a cylindrical axial recess 28 within the shaped end section 24.

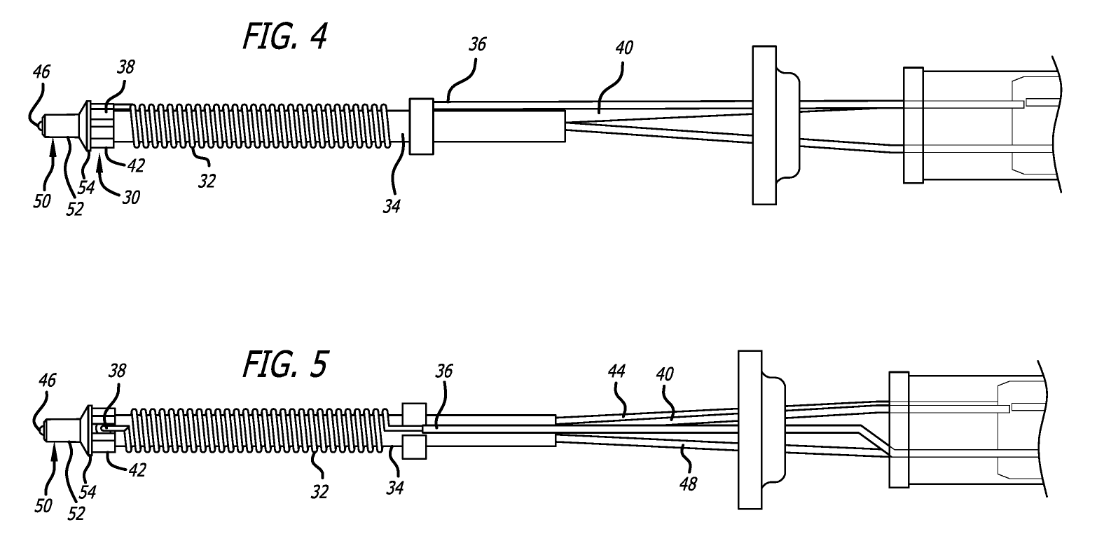

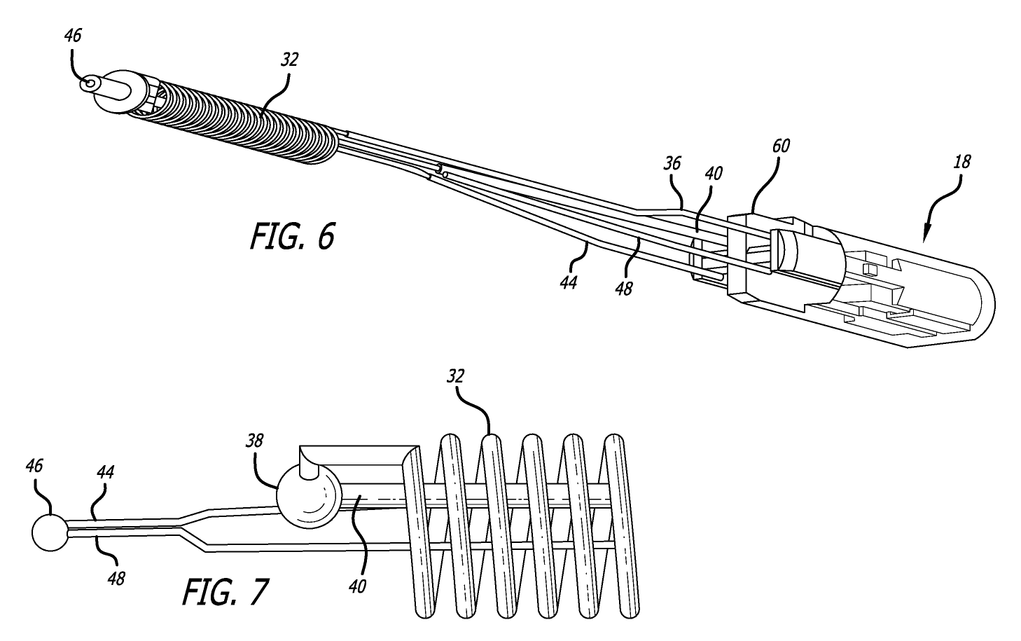

To simplify the depiction and description, the heater-dual sensor complex 30 is depicted removed from the tip 12 in a side view in FIG. 4, a top view in FIG. 5 and a perspective view in FIG. 6. The numbered components and following description applies to each of FIGS. 3-6.

The heater-dual sensor complex 30 includes a heater coil 32 wrapped around a hollow cylindrical ceramic sleeve 34. The proximal end of the heater coil 32 is connected to a power conductor 36. The distal end of the heater coil 32 is connected at a thermocouple 38 to a ground conductor 40. The thermocouple 38 is fixed within an insulator block 42.

A sensor conductor 44 extends from the connector assembly 18 through the central pipe body 16 and the cylindrical ceramic sleeve 34 and a bore through the insulator block 42 to a primary sensor thermocouple 46, which is formed by bonding the end of sensor conductor 44 to a distal end a sensor ground wire 48. The sensor ground wire 48 extends from the primary sensor thermocouple 46 proximally though the insulator block 42 and hollow axial bore of the cylindrical ceramic sleeve 34 and central pipe body 16 to the connector assembly 18. A hollow cap 50, having a stove-pipe-hat shape with a cylindrical section 52 and flange or brim section 54 encloses the distal portions of sensor conductor 44 and sensor ground wire 48, with the brim section of the cap 50 engaging the insulator block 42. The cap 50 is configured to provide a heat conducting path from a distal end of the heater coil 32 to the primary sensor thermocouple 46. The cap 50 may be formed from a copper, silver, copper alloy, silver alloy material, iron, aluminum, nickel, titanium, or stainless steel.

With the foregoing described construction, and as depicted in FIG. 3, the primary sensor thermocouple 46 is positioned within the shaped end section 24 of the tip 12, whereas the thermocouple 38, which acts as a sub-sensor, is positioned proximate to the distal end of the heater coil 32. The spacing between the primary sensor thermocouple 46 and the sub-sensor thermocouple 38 is preferably at least 1 mm and preferably in the range of between about 1 mm to 25 mm.

The heater coil 32 and the insulator block 42 are encased in a ceramic matrix 56 as depicted in FIG. 3. The method of fabricating the ceramic matrix 56 is detailed in the U.S. Pat. No. 6,054,678, incorporated by reference herein. The ceramic matrix 56 allows efficient heat transfer from the heater coil 32 to the hollow cylindrical section 22 and shaped end section 24 of the tip 32.

As best depicted in the partial phantom perspective view of FIG. 6, the connector assembly 18 includes divider block 60 to segregate the proximal ends of the power conductor 36, ground conductor 40, sensor conductor 44 and sensor ground wire 48. The connector assembly 18 preferably includes a pin connector to provide electrical connectivity to a cable extending from a handle to a power supply.

FIG. 7 is a side view depicting the distal ends of the heater coil 32 as well as sub-sensor thermocouple 38, ground conductor 40, sensor conductor 44, sensor ground wire 48 and primary sensor thermocouple 46. The heater coil 32 is formed from an iron-chromium-aluminum (FeCrAl) alloy, iron-chromium alloy or nickel-chromium alloy. The ground conductor 40 is a wire made from a conductive metallic material having a lower volume resistivity than the heater coil. Fusing the end of the iron-chromium-aluminum alloy wire of the heater coil 32 to the wire of ground conductor 40 forms the sub-sensor thermocouple 38. The electrical resistance of the thermocouple varies with temperature in a known manner, allowing a direct indication of the temperature at the thermocouple 38. The primary sensor thermocouple 46 may be for example a Type K thermocouple (nickel-chromium alloy/nickel-alumel alloy), with the sensor conductor 44 formed from a nickel-chromium alloy and the sensor ground wire 48 formed from a nickel-alumel alloy.

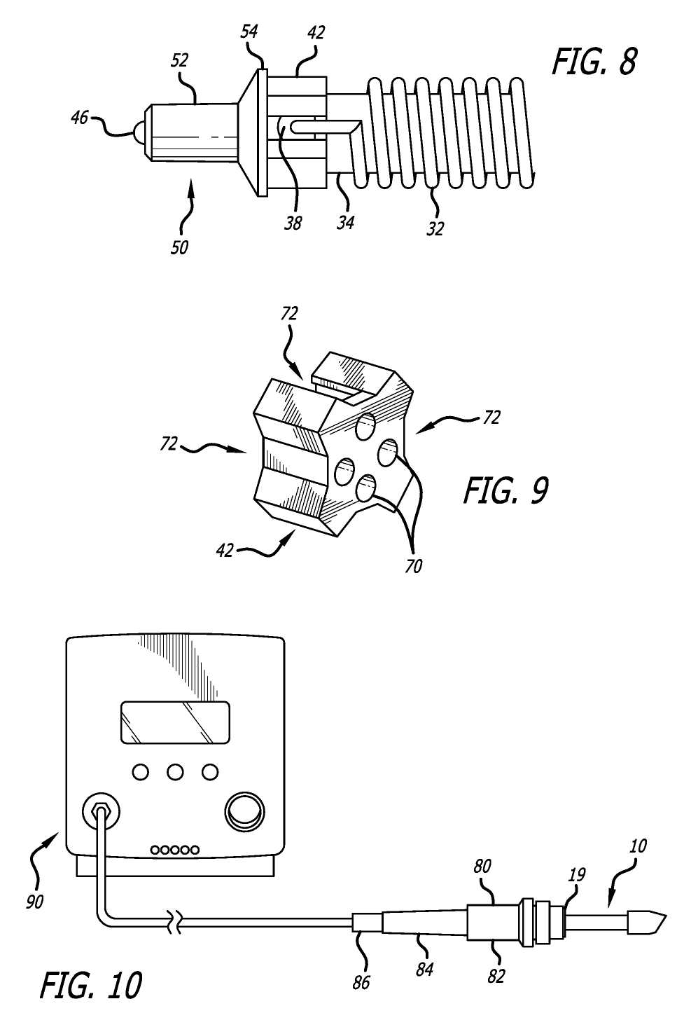

FIG. 8 is a side view depicting the primary sensor thermocouple 46 extending from the end of the cap 50, and the sub-sensor thermocouple 38 positioned in a recessed portion of the insulator block 42. The distal end of the cylindrical ceramic sleeve 34 fits into a recess in an end section of the insulator block 42.

FIG. 9 is a perspective view of the insulator block 42, showing the distal end that abuts the cap 50 depicted in FIG. 8. The insulator block 42 includes at least two bores 70 and recesses 72. The bores 70 allow for the insertion of the sensor conductor 44 and the sensor ground wire 48, which are then threaded axially through the cylindrical ceramic sleeve 34 (FIG. 8). One of the recesses 72 on the insulator block 42 accommodates the sub-sensor thermocouple 38.

As reflected in FIG. 3, during assembly the cylindrical section 52 of the cap 50 of the heater-dual sensor complex 30 is press-fitted in the cylindrical axial recess 28 inside of the shaped end section 24 of the tip 12 in order to securely fit the main sensor 46 at the distal end of the recess 28 for high thermal conductivity between the tip and main sensor 46.

FIG. 10 is side view of the cartridge 10 of the present invention inserted into a handle 80. The cartridge 10 may include a collar 19 having a first ring portion sized to fit snuggly within the distal end of the handle 80, and a second ring portion that abuts the distal end of the handle 80 when the cartridge 10 is fully inserted. As depicted in FIG. 10, the handle 80 includes a grip 82 and a body 84 connecting to a cable 86. The handle 80 includes a connector assembly positioned inside of the grip 82 configured to mate with the pin connector inside of the connector assembly 18 of the cartridge 10. The proximal end of cable 86 connects to a control station 90. The control station 90 includes circuitry to provide power to the cartridge 10, and a CPU to control the operation of the control station 90 to allow use with a number of different cartridges, each of which may have a specific power supply requirement and temperature profile.

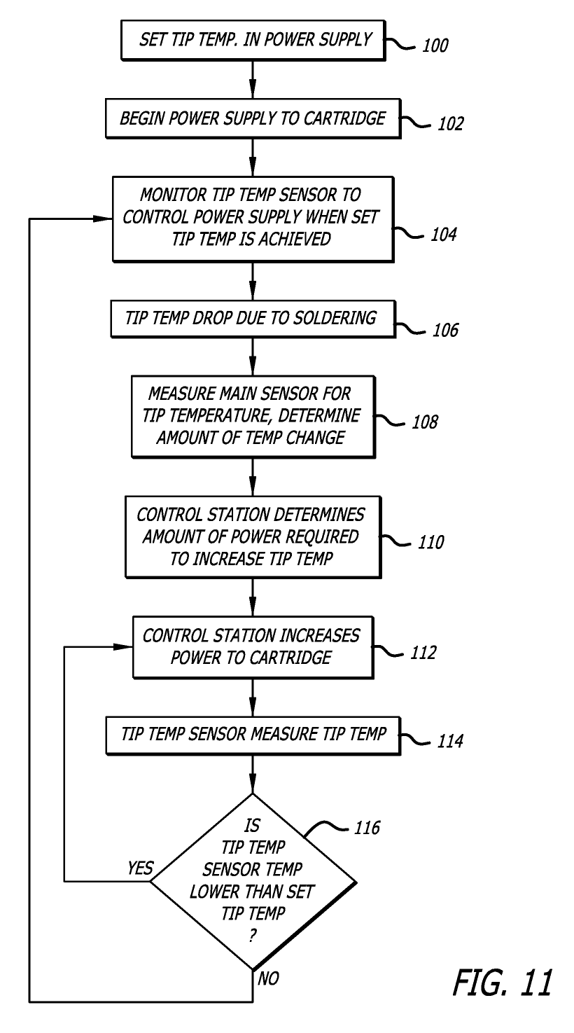

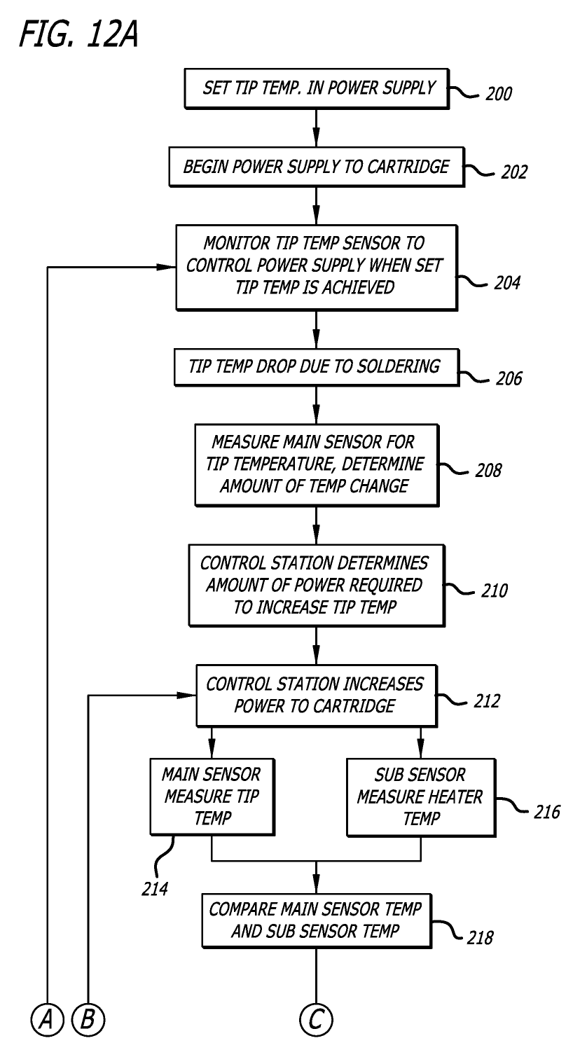

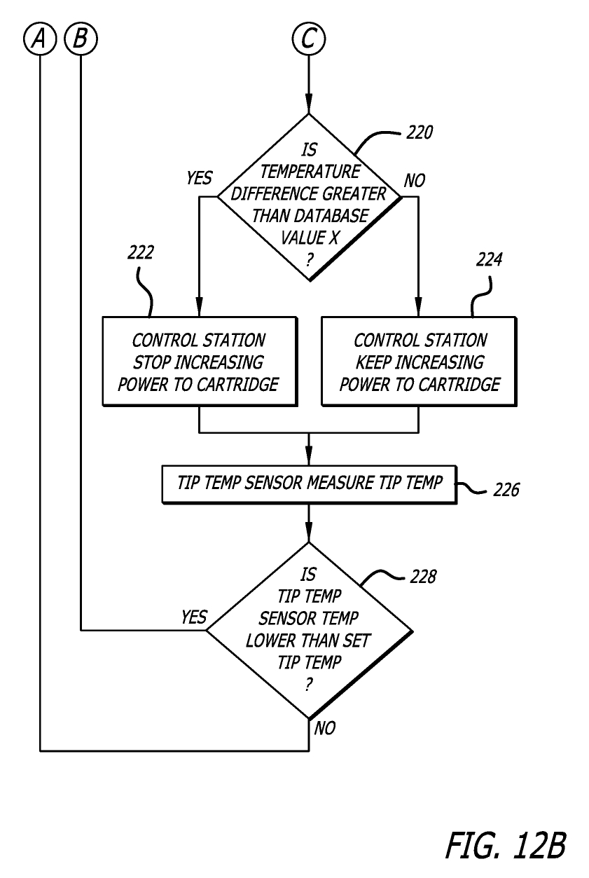

The CPU of the control station 90 is connected to circuitry which communicates the resistance values of the primary sensor thermocouple 46 and the sub-sensor thermocouple 38. The CPU is programmed with the resistance/temperature data for each type of thermocouple, whereby the CPU can monitor the temperature at both the primary sensor thermocouple 46 and the sub-sensor thermocouple 38, to control the delivery of power from the control station 90 to the cartridge 10, and specifically to the heater coil 32. By spacing the primary sensor thermocouple 46 distally from the distal end of the heater coil 32, and effectively deeper inside and closer to the end of the tip 12, the primary sensor thermocouple 46 can provide an accurate measurement of the temperature at the end of the tip 12. The temperature data from the primary sensor thermocouple 46 allows the CPU to control the delivery of power to the cartridge 10 using a control program, the logic of which is provided in the diagram of FIG. 11. However, the control function of the CPU may be enhanced by utilizing the temperature data from sub-sensor thermocouple 38 as a comparator, to prevent overheating of the tip 12, using a second control program, the logic of which is provided in the diagram of FIG. 12.

FIG. 11 is a logic diagram of the first control program of the CPU of the control station 90. The program starts at step 100 when the user sets the tip temperature for the cartridge. Next at step 102 the program causes the control station powers up the cartridge. Next at step 104 the program monitors the tip temperature sensor (primary sensor thermocouple 46) to control the power supply until the desired tip temperature is achieved. Next at step 106, the CPU determines that the tip temperature has dropped, which corresponds to the beginning of a soldering event. Next at step 108 the program determines the amount of the temperature change sensed by the tip temperature sensor. Next at step 110 the program determines the amount of additional power required to increase the tip temperature back to the set temperature. Next at step 112 the program increases the power output from the control station to the cartridge. Next at step 114 the program again measures the tip temperature from the tip temperature sensor. Next at step 116, the program makes the determination of whether the tip temperature is lower than the set tip temperature. If the tip temperature is lower, than the program returns to step 112 and the program increases the power from the control station to the cartridge. If at step 116 the tip temperature is not lower than the set tip temperature, then the program returns to step 104 to monitor the tip temperature sensor when the set tip temperature is achieved.

FIGS. 12A and 12B provide a logic diagram of the second control program of the CPU of the control station 90. The program starts at step 200 when the user sets the tip temperature for the cartridge. Next at step 202 the program causes the control station powers up the cartridge. Next at step 204 the program monitors the tip temperature sensor (primary sensor thermocouple 46) to control the power supply until the desired tip temperature is achieved. Next at step 206, the CPU determines that the tip temperature has dropped, which corresponds to the beginning of a soldering event. Next at step 208 the program determines the amount of the temperature change sensed by the tip temperature sensor. Next at step 210 the program determines the amount of additional power required to increase the tip temperature back to the set temperature. Next at step 212 the program increases the power output from the control station to the cartridge. As may be appreciated, up to this point the program is the same as the first control program.

After step 212, the program at step 214 obtains the tip temperature from the tip temperature sensor (primary sensor thermocouple 46) and simultaneously at step 216 obtains the heater temperature from the sub-sensor thermocouple 38. Next at step 218 the program compares the tip temperature from the primary sensor thermocouple 46 to the heater temperature provided by the sub-sensor thermocouple 38. Next, at step 220, from the two temperature measurements the program determines whether the heater temperature is greater than the tip temperature by a preset amount for the particular type of cartridge obtained from a database programmed into the control station. If the preset temperature difference is exceeded, the program proceeds to step 222 and the program instructs the power supply to control the power to the cartridge in such a manner so as to stop increasing, decrease, or stop the power to the cartridge. If at step 220 the preset temperature difference has not been exceeded, the program proceeds to step 224 and the program instructs the power supply to increase the power to the cartridge. The program proceeds from either step 222 or step 224 to step 226, where the program determines the tip temperature from the primary sensor thermocouple 46. Next, at step 228, the program determines if the tip temperature is less than the set tip temperature. If the determination at step 228 is yes, the tip temperature is less than the set temperature, then the program returns to step 212. However, if at step 228 the tip temperature is not less than the set temperature, then the program returns to step 204.

Using the second control program for the dual sensor heater complex, the sub-sensor thermocouple 38 positioned at the end of the heater coil 32 detects excessive heating. By comparing the temperature data from the sub-sensor thermocouple 38 to the temperature data from primary sensor thermocouple 46, the program in the control station can accurately control the delivery of power to the cartridge during the soldering task, while minimizing overheating of the tip when the soldering task is completed. As a result, the cartridge is capable of being powered with a 400 Watt power supply and the cartridge can be more efficient in maintaining the required tip temperature to allow repetitive soldering tasks.

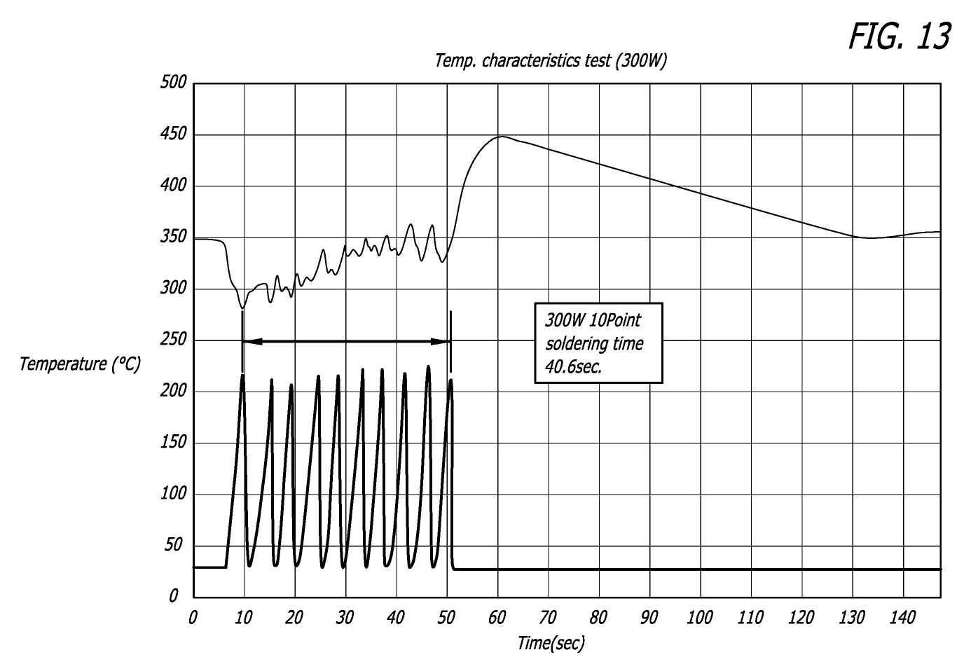

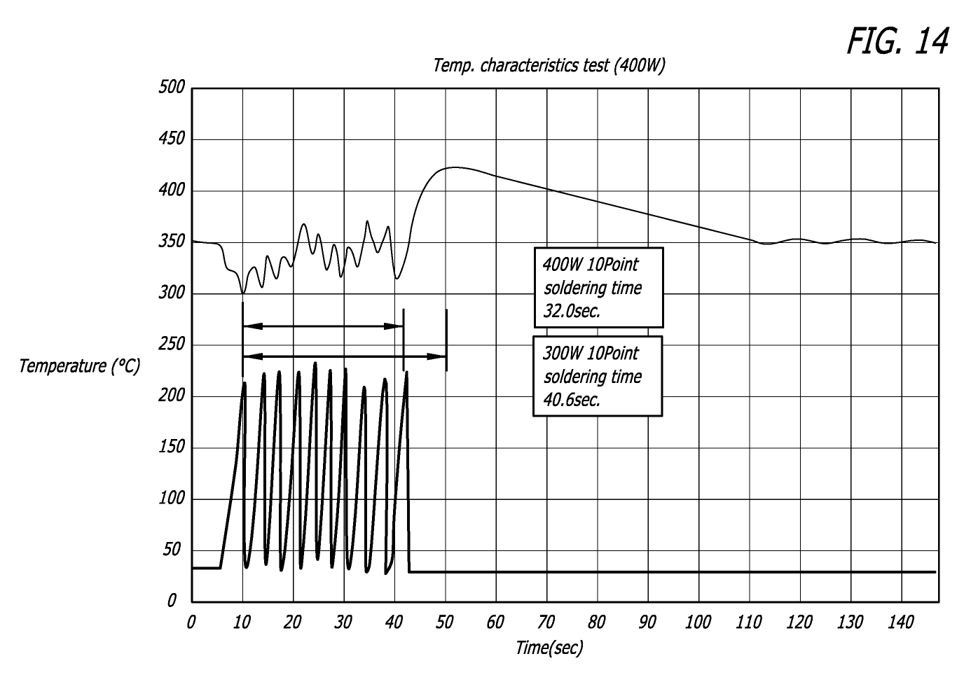

FIGS. 13 and 14 provide temperature vs. time graphs illustrating a comparative test of ten rapid soldering tasks to show the benefit of the dual sensor cartridge and control system. In the graphs of FIGS. 13 and 14, temperatures are shown on the “Y” axis and time in seconds is shown on the “X” axis. In FIG. 13, the top line is a temperature measurement for a 300 Watt cartridge having a single tip temperature sensor according to the prior art. The bottom line is the temperature graph of 10 soldering tasks. As reflected in the graph for the first 6 seconds the soldering cartridge has been heated to its set temperature of 350 degrees C. When the first soldering task starts, the cartridge tip temperature drops as the solder joint is being heated and the solder melts, with the soldering task being completed after 10 seconds. The cartridge is then immediately moved to start a second soldering task which as reflected in the lower portion of the graph is completed at just over 15 seconds. The tip temperature line on the top portion of the graph reflects the temperature drop at the outset of the soldering tasks, and the delayed recovery time to reestablish the 350 degree C. set temperature. For the 300 W cartridge tested and graphed in FIG. 13, the time from completion of the first soldering task to completion of the tenth soldering task is 40.6 seconds.

In FIG. 14, the top line is a temperature measurement for a 400 Watt cartridge having dual temperature sensors and the corresponding program according to the present invention. The bottom line is the temperature graph of 10 soldering tasks. As reflected in the graph for the first 6 seconds the soldering cartridge has been heated to its set temperature of 350 degrees C. When the first soldering task starts, the cartridge tip temperature drops as the solder joint is being heated and the solder melts, with the soldering task being completed after 10 seconds. The cartridge is then immediately moved to start a second soldering task which as reflected in the lower portion of the graph is completed at about 14 seconds. For the 400 W cartridge tested and graphed in FIG. 14, the time from completion of the first soldering task to completion of the tenth soldering task is 32 seconds. The graphs of FIGS. 13 and 14 illustrate that the 400 W dual sensor cartridge of the present invention can substantially decrease the time required for repetitive soldering tasks.

In addition, as reflected in the tip temperature data lines, after the ten soldering tasks were completed, the tip temperature of the prior art cartridge in FIG. 13 increased to 450 degrees C., or 100 degrees C. over the set point. By comparison, the tip temperature of the cartridge of the present invention in FIG. 14 increased to about 426 degrees C. As reflected in the graphs of FIGS. 13 and 14, the dual sensors for the 400 W cartridges of the present invention allow the control station program to limit the overheating of the cartridge tip at the end of the soldering cycle.

The invention has been described in detail above in connection with the appended figures. Those skilled in the art will appreciate that the foregoing disclosure is meant to be exemplary and specification and the figures are provided to explain the present invention, without intending to limit the potential modes of carrying out the present invention. The scope of the invention is defined only by the appended claims and equivalents thereto.

1. A dual temperature sensor soldering cartridge, comprising:
a hollow cartridge body;
a connector assembly mounted on a proximal end of the cartridge body;
a tip mounted on a distal end of the cartridge body; and
a dual sensor-heater assembly mounted within said tip, the assembly including a heater coil mounted around an insulation sleeve, a primary temperature sensor and a sub-sensor, said sub-sensor positioned proximate a distal end of said heater coil.

2. The dual temperature sensor soldering cartridge of claim 1, further comprising:
a power conductor attached to a proximal end of said heater coil, a ground conductor terminating at said sub-sensor to form a thermocouple with the distal end of said heater coil;
said primary temperature sensor comprising a primary sensor conductor and a primary sensor ground wire bonded together to form a thermocouple; and
said ground conductor, primary sensor conductor and primary sensor ground wire extending axially through said cartridge to said connector assembly.

3. The dual temperature sensor soldering cartridge of claim 1, wherein said heater coil is fabricated from a material selected from the group consisting of an iron-chromium-aluminum alloy, iron-chromium alloy and nickel chromium alloy and said sub-sensor is a thermocouple formed by bonding a distal end of said heater coil to a ground wire made from a conductive metallic material having a lower volume resistivity than the said heater coil, said ground wire extending from said sub-sensor axially through said cartridge to said connector assembly.

4. The dual temperature sensor soldering cartridge of claim 2, wherein said heater coil is fabricated from an iron-chromium-aluminum alloy, iron-chromium alloy or nickel chromium alloy and said sub-sensor is a thermocouple formed by bonding a distal end of said heater coil to a ground wire, said ground wire extending from said sub-sensor axially through said cartridge to said connector assembly.

5. The dual temperature sensor soldering cartridge of claim 2, wherein one of said primary sensor conductor and said primary sensor ground wire is formed from a nickel-chromium alloy wire and the other is formed from a nickel-alumel alloy wire.

6. The dual temperature sensor soldering cartridge of claim 1, further comprising:
an insulator block positioned at the distal end of said ceramic sleeve, said insulator block having at least one recess for receiving said sub-sensor.

7. The dual temperature sensor soldering cartridge of claim 1, further comprising:
a cap having a cylindrical section and a brim section, said cap enclosing distal portions of a sensor conductor and a sensor ground wire, said cap configured to provide a heat conducting path from a distal end of said heater coil to said primary temperature sensor.

8. The dual temperature sensor soldering cartridge of claim 1, wherein said primary temperature sensor is located closer to the distal end of the tip than to a distal end of the heater coil.

9. The dual temperature sensor soldering cartridge of claim 1, wherein said primary temperature sensor is positioned between 1 mm and 25 mm distally from said sub-sensor.

10. The dual temperature sensor soldering cartridge of claim 1, wherein said insulation sleeve is formed from a ceramic material.

11. The dual temperature sensor soldering cartridge of claim 2, wherein insulation sleeve includes passageways for said ground conductor, said primary sensor conductor and said primary sensor ground wire.

12. The dual temperature sensor soldering cartridge of claim 1, wherein said cap is formed from a copper, silver, copper alloy, silver alloy material, iron, aluminum, nickel, titanium, or stainless steel.

13. A dual temperature sensor soldering cartridge, comprising:
a hollow cartridge body;
a connector assembly mounted on a proximal end of the cartridge body;
a tip mounted on a distal end of the cartridge body;
a dual sensor-heater assembly mounted within said tip, the assembly including a heater coil mounted around an insulation sleeve, a primary temperature sensor and a sub-sensor, said sub-sensor positioned proximate a distal end of said heater coil;
an insulator block positioned at the distal end of said insulation sleeve, said insulator block having at least one recess for receiving said sub-sensor; and
a cap having a cylindrical section and a brim section, said cap enclosing distal portions of a sensor conductor and a sensor ground wire, said brim section of said cap positioned at a distal end of said insulator block.

14. The dual temperature sensor soldering cartridge of claim 13, further comprising:
a power conductor attached to a proximal end of said heater coil, a ground conductor terminating at said sub-sensor to form a thermocouple with the distal end of said heater coil;
said primary temperature sensor comprising a primary sensor conductor and a primary sensor ground wire bonded together to form a thermocouple; and
said ground conductor, primary sensor conductor and primary sensor ground wire extending axially through said cartridge to said connector assembly.

15. The dual temperature sensor soldering cartridge of claim 14, wherein said heater coil is fabricated from an iron-chromium-aluminum alloy, iron-chromium alloy of nickel-chromium alloy and said sub-sensor is a thermocouple formed by bonding a distal end of said heater coil to said ground conductor formed from a copper, nickel or iron wire, said ground conductor extending from said sub-sensor axially through said cartridge to said connector assembly and wherein one of said primary sensor conductor and said primary sensor ground wire is formed from a nickel-chromium alloy wire and the other is formed from a nickel-alumel alloy wire.

16. The dual temperature sensor soldering cartridge of claim 13, wherein said primary temperature sensor is positioned between 1 mm and 25 mm distally from said sub-sensor.

17. The dual temperature sensor soldering cartridge of claim 13, wherein insulation sleeve includes passageways for said ground conductor, said primary sensor conductor and said primary sensor ground wire.

18. The dual temperature sensor soldering cartridge of claim 13, wherein said cap is formed from a copper, silver, copper alloy, silver alloy material, iron, aluminum, nickel, titanium, or stainless.

19. A method for controlling the temperature of a soldering cartridge tip, comprising:
assembling a soldering cartridge having a hollow cartridge body, a connector assembly mounted on a proximal end of the cartridge body, a tip mounted on a distal end of the cartridge body and a dual sensor-heater assembly mounted within said tip, the assembly including a heater coil mounted around an insulation sleeve, a primary temperature sensor and a sub-sensor, said sub-sensor positioned proximate a distal end of said heater coil;
controlling the delivery of power to said heater coil based upon the primary temperature sensor providing a tip temperature signal and said sub-sensor providing a heater coil temperature signal by comparing the tip temperature from the primary sensor thermocouple to the heater temperature provided by the sub-sensor thermocouple, determining whether the heater temperature is greater than the tip temperature by a preset amount, and control the power to the heater coil based on the result of the comparison.

20. The method for controlling the temperature of a soldering cartridge tip of claim 19, wherein the controlling step further comprises when a preset temperature difference is exceeded, controlling the power to said heater coil to stop increasing, to decrease, or to stop the power to the heater coil and if the preset temperature difference has not been exceeded, controlling the power to said heater coil to increase the power to said heater coil.
